(19) United States
(12) Patent Application Publication
(10) Pub. No.: US 2026/0019774 A1
(43) Pub. Date: Jan. 15, 2026

(54) SYSTEMS AND METHODS FOR CONTEXT BASED LOCATION VERIFICATION IN A MONITORING SYSTEM

(71) Applicant: BI Incorporated, Boulder, CO (US)

(72) Inventors: Todd Bischoff, Westminster, CO (US); Duke Hanson, Boulder, CO (US)

(73) Assignee: BI Incorporated, Boulder, CO (US)

(21) Appl. No.: 18/772,761

(22) Filed: Jul. 15, 2024

(51) Int. Cl. H04W 4/029

(52) U.S. Cl. CPC H04W 4/029

(57) ABSTRACT

Various embodiments provide systems and methods for verifying location information provided from a monitoring device to a central monitoring station, and more particularly to systems and methods for using context to verify location information from a monitoring device.

### BACKGROUND OF THE INVENTION

Various embodiments provide systems and methods for verifying location information provided from a monitoring device to a central monitoring station, and more particularly to systems and methods for using context to verify location information from a monitoring device.

Tracking devices have been attached to and/or carried by monitored individuals and provide an ability to automatically determine the location of the respective monitored individual. Such tracking devices can include, for example, location determination circuitry that depends upon, for example, signal reception from location satellites, WiFi devices, and/or transmitting beacons. The location services provide a location of the tracking device, and thus to identify the location of the individual the tracking device must be in proximity of the individual. It may be possible to cause a monitoring device associated with a monitored individual to report a fictitious location which defeats the ability to ascertain the location of the monitored individual based upon information provided by the monitoring device.

Thus, for at least the aforementioned reasons, there exists a need in the art for more advanced approaches, devices and systems for verifying location information provided from a monitoring device.

### BRIEF SUMMARY OF THE INVENTION

Various embodiments provide systems and methods for verifying location information provided from a monitoring device to a central monitoring station, and more particularly to systems and methods for using context to verify location information from a monitoring device.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIGS. 1A-1D are block diagrams illustrating a location monitoring system that includes a user attached monitoring device and central monitoring station where one or both of the user attached monitoring device and/or central monitoring station is configured to verify location information provided by the user attached monitoring device or another monitoring device (not shown) to the central monitoring station in accordance with various embodiments;

FIGS. 2A-2D are block diagrams illustrating a location monitoring system that includes a user detached monitoring device and central monitoring station where one or both of the user detached monitoring device and/or central monitoring station is configured to verify location information provided by the user detached monitoring device or another monitoring device (not shown) to the central monitoring station in accordance with some embodiments;

FIG. 3 is a block diagram of a location monitoring system including a hybrid monitoring system including a user attached monitoring device secured to a monitored individual using a securing buckle in accordance with various embodiments;

FIG. 4 is a flow diagram showing a method in accordance with some embodiments for verifying location information provided from a monitoring device in a monitoring system;

FIGS. 5A-5F depict different verification scenarios that may be used in relation to various embodiments; and

FIG. 6 shows a computer system that may be used in relation to one or more embodiments.

### DETAILED DESCRIPTION OF THE INVENTION

Various embodiments provide systems and methods for using context to verify location information from a monitoring device.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “cell” includes reference to one or more of such cells.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the elements shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

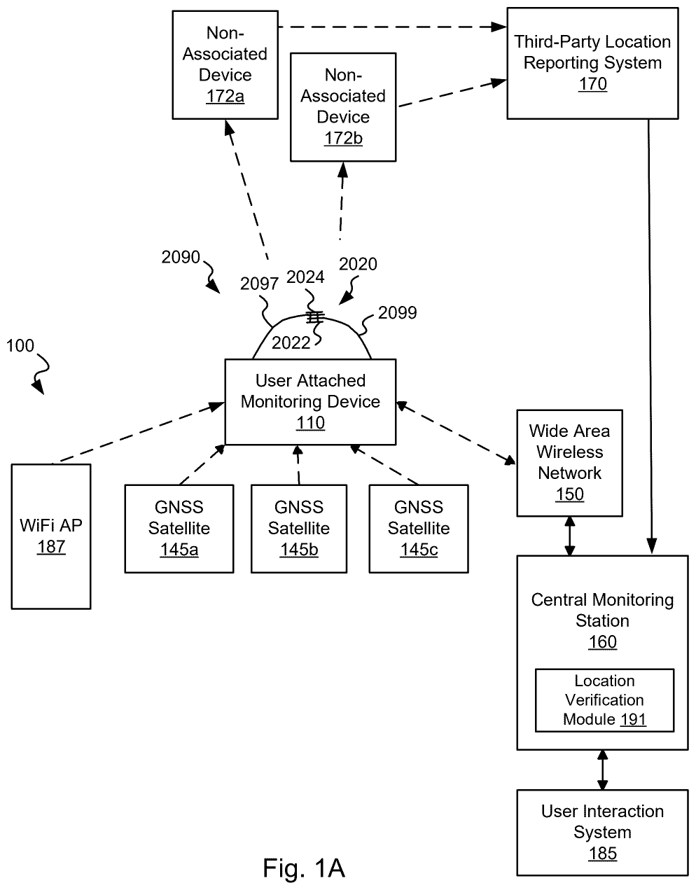

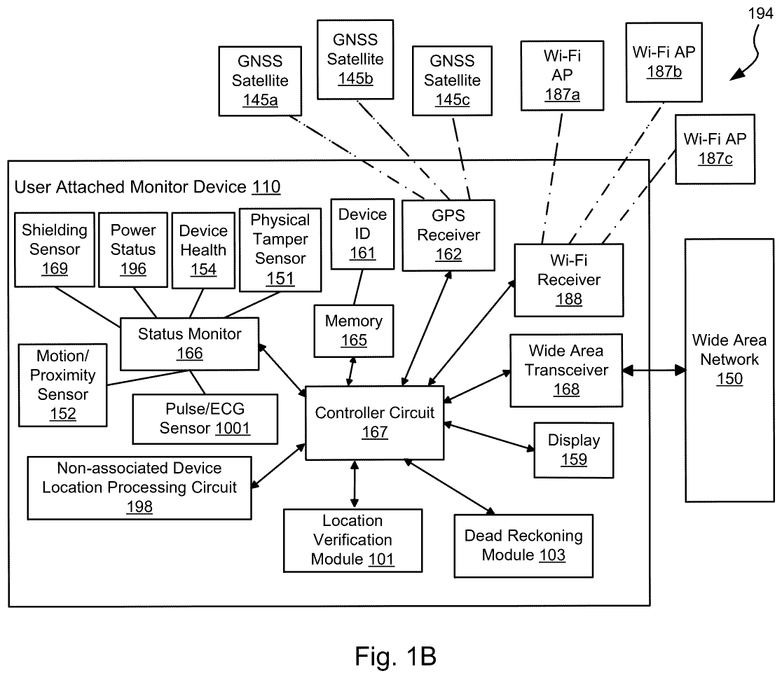

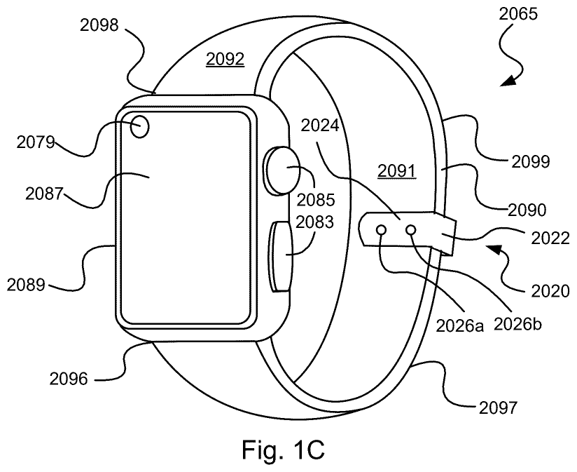

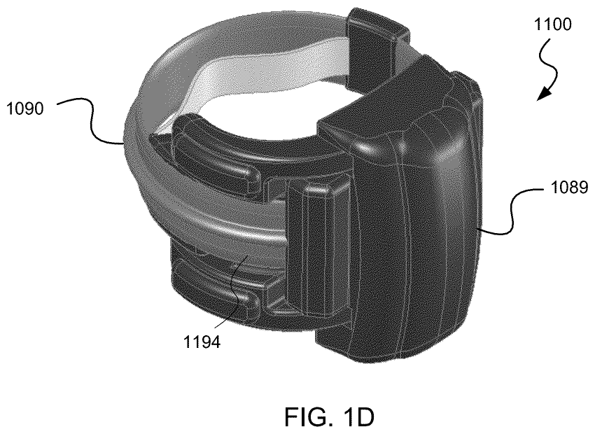

In the following description of FIGS. 1-6, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Various embodiments provide methods for determining the location of a monitored individual that include generating, by a monitoring device, a first location information for the monitoring device, where the monitoring device is associated with the monitored individual. The monitoring device may be, but is not limited to, a user attached monitoring device or a user detached monitoring device. The user detached monitoring device may be, but is not limited to: a mobile phone, or a mobile alcohol breath tester; and the user attached monitoring device may be, but is not limited to, a wrist worn monitoring device, or an ankle worn monitoring device. The methods further include: receiving, from a context system, a second location information for the monitoring device; comparing the first location information with the second location information; and indicating a veracity of the first location information based at least in part on comparing the first location information with the second location information.

In some instances of the aforementioned embodiments, the monitoring device is a user attached monitoring device and the context system includes a user detached monitoring device associated with the monitored individual. In other instances of the aforementioned embodiments, the monitoring device is a user detached monitoring device and the context system comprises a user attached monitoring device associated with the monitored individual. In various instances of the aforementioned embodiments, the context system includes a non-associated device and a third-party reporting system.

In various instances of the aforementioned embodiments, the methods further include receiving, by a central monitoring station, both the first location information and the second location information. Comparing the first location information with the second location information and indicating the veracity of the first location information is done by the central monitoring station. In other instances of the aforementioned embodiments, the methods further include receiving, by the monitoring device, the second location information. Comparing the first location information with the second location information and indicating the veracity of the first location information is done by the monitoring device. In some such instances, the methods further include transmitting, by the monitoring device, the first location information to a central monitoring station. Indicating the veracity of the first location information based at least in part on comparing the first location information with the second location information includes: generating a veracity indication based at least in part on comparing the first location information with the second location information; and transmitting the veracity indication to the central monitoring station. In various instances, the context system comprises a dead reckoning module of the monitoring device.

Other embodiments provide individual location monitoring systems that include: a monitoring device associated with a monitored individual configured to generated a first location information; a context system configured to generate a second location information; a processor; and a computer readable medium communicably coupled to the processor. The computer readable medium has stored therein instructions which when executed by the processor cause the processor to: receive the second location information; compare the first location information with the second location information; and indicate a veracity of the first location information based at least in part on comparing the first location information with the second location information.

Turning to FIG. 1A, a block diagram illustrates a monitoring system 100 including a user attached monitoring device 110 and a central monitoring station 160. Central monitoring station 160 is wirelessly coupled to user attached monitoring device 110 via one or more wide area wireless (e.g., cellular telephone network, Internet via a WiFi access point, or the like) communication networks 150. User attached monitoring device 110 may include an attachment element 2090 with a first end 2097 and a second end 2099. Each of first end 2097 and second end 2099 includes one or more holes through which a male connector of a securing buckle 2020 may pass. When securing buckle 2020 is installed, first end 2097 overlaps second end 2099 such that the one or more holes align, and corresponding male connectors extending from a first side 2025 of securing buckle 2020 pass through the aligned one or more hole in first end 2097 and second end 2099, and into corresponding female connectors of a second side 2024 of securing buckle 2020. In some cases, an electrically conductive material passes through a middle area of attachment element 2090 and connects to different locations of user attached monitoring device 110. One or more of the male connectors extending from the first side 2025 of securing buckle 2020 may include an electrically conducive portion that acts to complete an electrical connection extending through attachment element 2090 when the male connector(s) is installed. Thus, with the male connector(s) installed, an electrical signal can be passed by user attached monitoring device from one end of attachment element 2090 to another end of attachment element 2090 where it is received by user attached monitoring device 110 at another location. Where user attached monitoring device detects a discontinuity in the previously established electrical connection, it provides an indication that user attached monitoring device 110 may have been removed by either cutting attachment element 2090 or removing the male connector(s).

Central monitoring station 160 may be any location, device or system where location data and/or other types of data are received, including by way of non-limiting example: a cellular/smart phone, an email account, a website, a network database, and a memory device. The location data and/or other types of data are stored by central monitoring station 160 and are retrievable by a monitoring individual, such as a parent, guardian, parole officer, court liaison, spouse, friend, or other authorized group or individual. In this manner, the monitoring individual is able to respond appropriately to detected activity of a monitored individual. In some cases, the monitoring individual is able to retrieve the location data and/or other data types via a user interaction system 185 which may be, but is not limited to, a network connected user interface device communicatively coupled via a network to central monitoring station 160 and/or directly to user attached monitoring device 110 via wide area wireless network 150.

Central monitoring station 160 may include a server supported website, which may be supported by a server system comprising one or more physical servers, each having a processor, a memory, an operating system, input/output interfaces, and network interfaces, all known in the art, coupled to the network. The server supported website comprises one or more interactive web portals through which the monitor may monitor the location of the monitored individual in accordance with the described embodiments. In particular, the interactive web portals may enable the monitor to retrieve the location and user identification data of one or more monitored individuals, set or modify ‘check-in’ schedules, and/or set or modify preferences. The interactive web portals are accessible via a personal computing device, such as for example, a home computer, laptop, tablet, and/or smart phone.

In some embodiments, the server supported website comprises a mobile website or mobile application accessible via a software application on a mobile device (e.g. smart phone). The mobile website may be a modified version of the server supported website with limited or additional capabilities suited for mobile location monitoring.

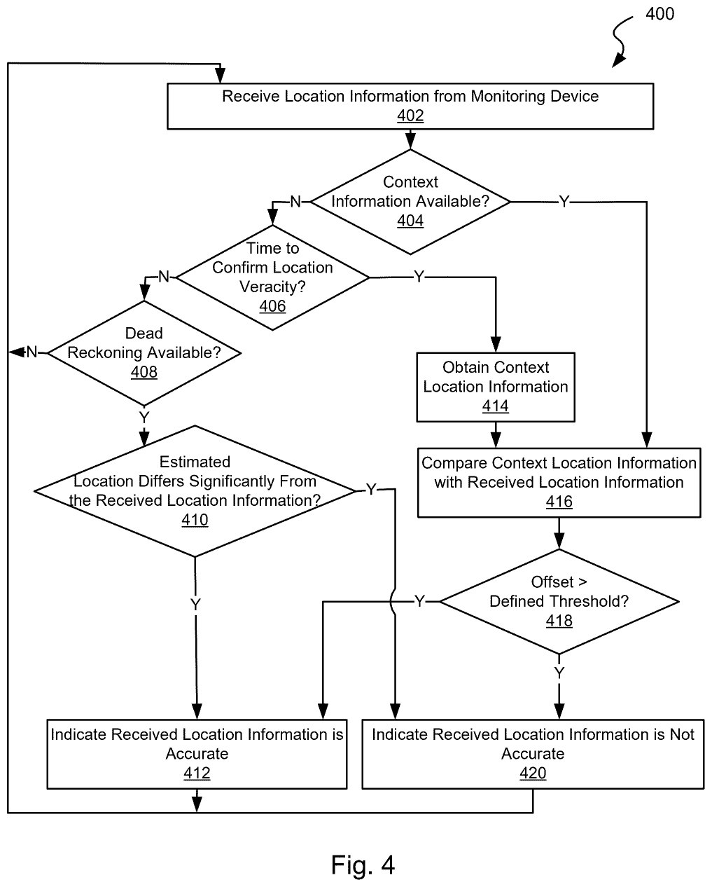

In various embodiments, location information from user attached monitoring device 110 is provided to central monitoring station 160 where it is verified. In such embodiments, a location verification module 191 may be used to verify the location information provided by user attached monitoring device 110 to central monitoring station 160. Location verification module 191 may include, for example, a computer readable medium having instructions executed by a processor of central monitoring station 160 to perform the processes discussed below in relation to FIG. 4. As such, location verification module 191 may be configured to receive location information from user attached monitoring device 110 and to perform verification of the received location information. In some cases, this verification of the received location information may include a comparison of the received location information with location information generated by another monitoring device or from third-party location reporting system 170.

User attached monitoring device 110 includes a location sensor that senses the location of user attached monitoring device 110 and generates corresponding location data. For example, when user attached monitoring device 110 is capable of receiving wireless global navigation satellite system (hereinafter “GNSS”) location information from a sufficient number of GPS or GNSS satellites 145 (i.e., one or more of GNSS satellited 145a, GNSS satellited 145b, GNSS satellited 145c) respectively, user attached monitoring device 110 may use the received wireless GNSS location information to calculate or otherwise determine the location of a human subject to which user attached monitoring device 110 is attached. Global positioning system (hereinafter “GPS) is one example of a GNSS location system. While GPS is used in the specific embodiments discussed herein, it is recognized that GPS may be replaced by any type of GNSS system. In some instances, this location includes latitude, longitude, and elevation. It should be noted that other types of earth-based triangulation may be used in accordance with different embodiments of the present invention. For example, other cell phone-based triangulation, UHF band triangulation such as, for example, long range (hereinafter “LoRa”) triangulation signals. Based on the disclosure provided herein, one of ordinary skill in the art will recognize other types of earth-based triangulation that may be used. The location data may comprise one or more of, but is not limited to: global positioning system (“GPS”) data, Assisted GPS (“A-GPS”) data, Advanced Forward Link Trilateration (“AFLT”) data, and/or cell tower triangulation data. Where GPS is used, user attached monitoring device 110 receives location information from three or more GPS or GNSS satellites 145 via respective communication links. The location data and/or other data gathered by user attached monitoring device 110 is wirelessly transmitted to central monitoring station 160 via wide area wireless network 150 accessed via a wireless link 135.

Further, user attached monitoring device 110 includes WiFi based location determination circuitry that is configured to communicate with one or more WiFi access points 187, and based thereon to determine location of user attached monitoring device 110.

Yet further, user attached monitoring device 110 includes non-associated device-based location determination circuitry that is configured to sense that one or more non-associated devices 172 (e.g., a non-associated device 172a and/or a non-associated device 172b) is/are within range of user attached monitoring device 110, and to communicate (i.e., transmit) an identification of user attached monitoring device 110 to the identified non-associated device. In some embodiments, the aforementioned communications are performed via BlueTooth™ or another relatively short range, low-power communication protocol. Based upon the disclosure provided herein, one of ordinary skill in the art will recognize a variety of protocols that may be used for communications between user attached monitoring device 110 and a nearby non-associated device 172.

In turn, the non-associated device that received the identification information from user attached monitoring device 110 reports the identification received from user attached monitoring device 110 and the location of the non-associated device to a third-party location reporting system 170. Third-party location reporting system 170 in turn transfers the received identification and location information to a recipient registered with the received identification in third-party location reporting system 170. In this case, the recipient registered with the received identification in third-party location reporting system 170 is central monitoring station 160. In such a case, a location of the non-associated device that provided the identification of user attached monitoring device 110 to third-party location reporting system 170 is established by central monitoring station 160 as the location of user attached monitoring device 110. The power requirements of the user attached monitoring device 110 for identifying the non-associated device and communicating the identification to the non-associated device are less than that required to determine location based either on WiFi access points 187 or GNSS satellites 145.

Turning to FIG. 1B, a block diagram 194 of user attached monitoring device 110 is shown in accordance with some embodiments. As shown, user attached monitoring device 110 includes a device ID 161 that may be maintained in a memory 165 and is thus accessible by a controller circuit 167. Controller circuit 167 interacts with a GPS receiver 162 and memory 165 at times for storing and generating records of successively determined GPS locations. Similarly, controller circuit 167 interacts with a WiFi receiver 188 and memory 165 at times for storing and generating records of successively determined WiFi access point identifications and signal strength. In some cases, memory 165 may include instructions (e.g., software-based or firmware-based instructions) executable by controller circuit 167 to perform and/or enable various functions associated with user attached monitoring device 110. As user attached monitoring device 110 comes within range of one or more WiFi access points (e.g., a WiFi access point 187a, a WiFi access point 187b, and/or a WiFi access point 187c), WiFi receiver 188 senses the signal provided by the respective WiFi access points, and provides an identification of the respective WiFi access point and a signal strength of the signal received from the WiFi access point to WiFi receiver 188. This information is provided to controller circuit 167 which stores the information to memory 165.

Additionally, user attached monitoring device 110 includes a non-associated device location processing circuit 198. Non-associated device location processing circuit 198 is configured to sense that one or more non-associated devices 172 is/are within range of user attached monitoring device 110, and to communicate (i.e., transmit) an identification of user attached monitoring device 110 to the identified non-associated device. In turn, the non-associated device that received the identification information from user attached monitoring device 110 reports the identification received from user attached monitoring device 110 and the location of the non-associated device to third-party location reporting system 170. Third-party location reporting system 170 in turn transfers the received identification and location information to a recipient registered with the received identification in the system. In this case, the recipient registered with the received identification in the system is central monitoring station 160. The power requirements of the user attached monitoring device 110 for identifying the non-associated device and communicating the identification to the non-associated device are substantially less than determining location based either on WiFi access points 187 or GNSS satellites 145.

Where user attached monitoring device 110 is operating in a standard mode, controller circuit 167 causes an update and reporting of the location of user attached monitoring device 110 via a wide area transceiver 168 and wide area communication network 150. In some embodiments, wide area transceiver 168 is a cellular telephone transceiver. In some cases, the location data is time stamped. In contrast, where user attached monitoring device 110 is within range of a public WiFi access point, reporting the location of user attached monitoring device 110 may be done via the public WiFi access point in place of the cellular communication link. In other modes triggered by conditions in user detached monitoring device 110, controller circuit 167 causes non-associated device location processing circuit 198 to provide for reporting a proxy for the location of user attached monitoring device 110 by transmitting its identification to any non-associated device 172 within range. In such a case, the proxy for the location is the location of the non-associated device 172 that received identification from user attached monitoring device 110. Conditions for using the proxy location by communicating the identification information of user attached monitoring device 110 are discussed more fully in relation to FIGS. 4-8 below.

Which technologies (e.g., GNSS and/or WiFi) are used to update the location of user attached monitoring device 110 may be selected either by default, by programming from central monitor station 160, or based upon conditions detected in user attached monitoring device 110 with corresponding pre-determined selections. For example, it may be determined whether sufficient battery power as reported by power status 196 remains in user attached monitoring device 110 to support a particular position determination technology. Where insufficient power remains, using the proxy location by communicating the identification information of user attached monitoring device 110 to a non-associated device 172 may be enabled and other location technologies disabled.

In some cases, a maximum cost of resolving location may be set for user attached monitoring device 110. For example, resolving WiFi location data or via a non-associated device may incur a per transaction cost to have a third-party service provider resolve the location information. When a maximum number of resolution requests have been issued, the WiFi position determination technology or the non-associated device approach may be disabled.

Further, it may be determined whether the likelihood that a particular position determination technology will be capable of providing meaningful location information. For example, where user attached monitoring device 110 is moved indoors, GPS receiver 162 may be disabled to save power. Alternatively, where the tracking device is traveling at relatively high speeds, WiFi receiver 188 may be disabled. As yet another example, where cellular phone jamming is occurring, support for cell tower triangulation position determination may be disabled. As yet another example, where GPS jamming is occurring, GPS receiver 162 may be disabled. As yet another example, where user attached monitoring device 110 is stationary, the lowest cost (from both a monetary and power standpoint) tracking may be enabled while all other technologies are disabled. Which position determination technologies are used may be based upon a zone in which a tracking device is located. Some zones may be rich in WiFi access points and in such zones WiFi technology may be used. Otherwise, another technology such as cell tower triangulation or GPS may be used. Based upon the disclosure provided herein, one of ordinary skill in the art will recognize other scenarios and corresponding combinations of technologies may be best.

Where user attached monitoring device 110 is operating in a standard mode, controller circuit 167 causes an update and reporting of the location of user attached monitoring device 110 via a wide area transceiver 168 and wide area communication network 150. In some embodiments, wide area transceiver 168 is a cellular telephone transceiver. In some cases, the location data is time stamped. In contrast, where user attached monitoring device 110 is within range of a public WiFi access point, reporting the location of user attached monitoring device 110 may be done via the public WiFi access point in place of the cellular communication link. In other modes triggered by conditions in user detached monitoring device 110, controller circuit 167 causes non-associated device location processing circuit 198 to provide for reporting a proxy for the location of user attached monitoring device 110 by transmitting its identification to any non-associated device 172 within range. In such a case, the proxy for the location is the location of the non-associated device 172 that received identification from user attached monitoring device 110. Conditions for using the proxy location by communicating the identification information of user attached monitoring device 110 are discussed more fully in U.S. patent application Ser. No. 18/481,496 filed Oct. 5, 2023 by Hanson et. al. The entirety of the aforementioned reference is incorporated herein by reference for all purposes.

Which technologies (e.g., GNSS and/or WiFi) are used to update the location of user attached monitoring device 110 may be selected either by default, by programming from central monitor station 160, or based upon conditions detected in user attached monitoring device 110 with corresponding pre-determined selections. For example, it may be determined whether sufficient battery power as reported by power status 196 remains in user attached monitoring device 110 to support a particular position determination technology.

In some cases, a maximum cost of resolving location may be set for user attached monitoring device 110. For example, resolving WiFi location data or via a non-associated device may incur a per transaction cost to have a third-party service provider resolve the location information. When a maximum number of resolution requests have been issued, the WiFi position determination technology or the non-associated device approach may be disabled.

Further, it may be determined whether the likelihood that a particular position determination technology will be capable of providing meaningful location information. For example, where user attached monitoring device 110 is moved indoors, GPS receiver 162 may be disabled to save power. Alternatively, where the tracking device is traveling at relatively high speeds, WiFi receiver 188 may be disabled. As yet another example, where cellular phone jamming is occurring, support for cell tower triangulation position determination may be disabled. As yet another example, where GPS jamming is occurring, GPS receiver 162 may be disabled. As yet another example, where user attached monitoring device 110 is stationary, the lowest cost (from both a monetary and power standpoint) tracking may be enabled while all other technologies are disabled. Which position determination technologies are used may be based upon a zone in which a tracking device is located. Some zones may be rich in WiFi access points and in such zones WiFi technology may be used. Otherwise, another technology such as cell tower triangulation or GPS may be used. Based upon the disclosure provided herein, one of ordinary skill in the art will recognize other scenarios and corresponding combinations of technologies may be best.

Controller circuit 167 of user attached monitoring device 110 at times functions in conjunction with wide area transceiver 168 to send and receive data and signals through wide area communication network 150. This link at times is useful for passing information and/or control signals between a central monitoring system 160 and user attached monitoring device 110. The information transmitted may include, but is not limited to, location information, measured alcohol information, one or more passive or active impairment tests applied to the monitored individual, and information about the status of user attached monitoring device 110. Based on the disclosure provided herein, one of ordinary skill in the art will recognize a variety of information that may be transferred via wide area communication network 150.

Various embodiments of user attached monitoring device 110 include a variety of sensors capable of determining the status of user attached monitoring device 110, and of the individual to which it is attached. For example, a status monitor 166 may include one or more of the following subcomponents: power status sensor 196 capable of indicating a power status of user attached monitoring device 110, and/or a pulse/ECG sensor 1001 operable to sense pulse rate of the monitored individual and an electrocardiogram unique to the monitored individual based upon electrodes (not shown) in contact with the skin of the monitored individual. The power status may be expressed, for example as a percentage of battery life remaining. Based upon the disclosure provided herein, one of ordinary skill in the art will recognize a variety of forms in which power status may be expressed. The pulse rate may be expressed in beats per minute and the ECG may be shown visually via display 159. Based upon the disclosure provided herein, one of ordinary skill in the art will recognize a variety of forms in which pulse rate and/or ECG rate may be expressed.

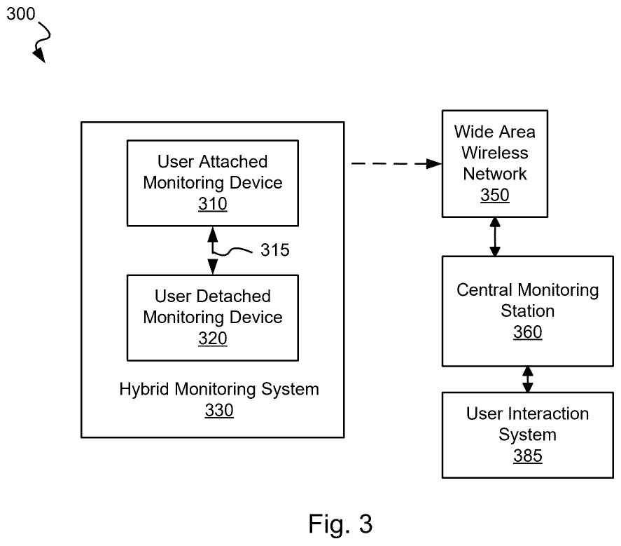

In addition, user attached monitoring device 110 includes a set of shielding sensors 169 that are capable of determining whether user attached monitoring device 110 is being shielded from receiving GPS signals and/or if GPS jamming is ongoing, a set of device health indicators 154, a tamper sensor 151 capable of determining whether unauthorized access to user attached monitoring device 110 has occurred or whether user attached monitoring device 110 has been removed from an associated individual being monitored, and/or a motion/proximity sensor 152 capable of determining whether user attached monitoring device 110 is moving and/or whether it is within proximity of an individual associated with user detached monitoring device (not shown-see FIG. 3) associated with the monitored individual. In some cases, motion/proximity sensor 152 includes one or more accelerometer sensors and/or vibration gyro sensors that are capable of accurately sensing motion of the monitored individual. In addition, motion/proximity sensor 152 includes sensors capable of determining a proximity of user attached monitoring device 110 to a monitored individual to which the device is assigned. This information may be used to assure that the monitored individual is wearing user attached monitoring device 110. Based on the disclosure provided herein, one of ordinary skill in the art will recognize a variety of shielding sensors, a variety of device health transducers and indicators, a variety of tamper sensors, various different types of motion sensors, different proximity to human sensors, and various human body physical measurement sensors or transducers that may be incorporated into user attached monitoring device 110 according to various different instances and/or embodiments.

In some embodiments, a user input (not shown) may be integrated into a display 159 and allows for a user of user attached monitoring device 110 to provide information to user attached monitoring device 110. Display 159 is communicatively coupled to controller circuit 167.

In some embodiments, a location verification module 101 is included. Location verification module 101 may include, for example, a computer readable medium having instructions executed by controller circuit 167 to perform the processes discussed below in relation to FIG. 4. As such, location verification module 101 may be configured to receive location information from another monitoring device and to perform verification of the received location information. In some cases, this verification of the received location information may include a comparison of the received location information with location information generated by user attached monitoring device 110. As an example, user attached monitoring device may be attached to a monitored individual and a user detached monitoring device (e.g., a mobile phone) may be associated with the same monitored individual and be providing location information for the monitored individual. The location information from the user detached monitoring device may be provided to only user attached monitoring device 110 via a wireless communication link, and in such a case the received location information may be being verified by user attached monitoring device 110 using the processes of FIG. 4 before being reporting to central monitoring station 160. In other cases, the location information from the user detached monitoring device may be provided to both user attached monitoring device 110 and central monitoring station 160 via wireless communication links, and in such a cases the received location information may be being verified by user attached monitoring device 110 using the processes of FIG. 4 and in turn a verification message is sent by user attached monitoring device 110 to central monitoring station.

In other embodiments, location information from user attached monitoring device 110 is provided to central monitoring station 160 where it is verified. In such embodiments, location verification module 191 of central monitoring station may be used to verify the location information provided by user attached monitoring device 110.

In some embodiments, a dead reckoning module 103 is included. Dead reckoning module 103 may include, for example, a computer readable medium having instructions executed by controller circuit 167 to determine an estimated location of user attached monitoring device 110 based upon a location previously determined using one or more of GPS receiver 192, or WiFi receiver 188 and modifying that location based upon movement information sensed by user attached monitoring device 110. The sensed motion information may include, but is not limited to acceleration, motion, steps, or any other movement information sensed by motion/proximity sensor 152. Thus, as an example, dead reckoning module 103 may receive a location of X, Y, Z at a time t₀. At a time t₁, motion/proximity sensor 152 may have indicated N steps which is estimated to be N*Conversion feet, but no direction. In such a case, dead reckoning module 103 may estimate the location of user attached monitoring device 110 as X′, Y′, where X′ is X+/−N*Conversion feet and Y′ is Y+/−N*Conversion feet. Based upon the disclosure provided herein, one of ordinary skill in the art will recognize a variety of location estimations that may be used in relation to different embodiments, and/or approaches for performing dead reckoning in accordance with different embodiments.

Turning to FIG. 1C, a user attached monitoring device 2065 is shown with attachment element 2090 connected at opposite ends of user attached monitoring device 2065 (i.e., a first end 2096 of user attached monitoring device 2065 and a second end 2098 of user attached monitoring device 2065). User attached monitoring device 2065 is one example implementation of user attached monitoring device 110 of FIGS. 1A-1B. Attachment element 2090 has an outer surface 2092 and an inner surface 2091. Attachment element 2090 is operable to securely attach a user attached monitoring device 2065 to a limb of a monitored individual in accordance with some embodiments. In some cases, attachment element 2090 is tailored to attach to a wrist of a monitored individual. In various embodiments, attachment element 2090 includes electrically conductive material used to make a conductive connection from first end 2096 to second end 2098 through attachment element 2090 and is used in relation to determining whether user attached monitoring device 2065 remains attached and/or has been tampered with. In some such instances, connection from first end 2096 to second end 2098 via the electrically coupled element is made by an electrically coupled male connector(s) (not shown) included as part of securing buckle expending through attachment element 2090 and secured to one or more of female connectors 2026a, 2026b of a side 2024 of securing buckle 2020. A center area 2022 of securing buckle 2020 connects side 2024 of securing buckle 2020 to another side 2028 of securing buckle 2020. Side 2028 of securing buckle 2020 is not shown in this drawing as it is on the opposite side of attachment element 2090. Thus, for example, where attachment element 2090 is cut or the male connectors pulled out, the conductive connection is broken indicating a tamper has occurred. While FIG. 1C shows a strap as an example attachment element, based upon the disclosure provided herein, one of ordinary skill in the art will recognize other types of attachment elements that may be used in relation to different embodiments. In other embodiments, attachment element 2090 is long enough to attach around the torso of the monitored individual and is sufficiently flexible to allow expansion and contraction of the chest of the monitored individual as they breath. Such expansion and contraction may be used to sense respiration rate of the monitored individual.

User attached monitoring device 2065 includes a case 2089 in which various electronic components are maintained. In addition, user attached monitoring device 2065 includes a button 2083, a radial dial 2085, a display 2087 (which may be a touchscreen display), and a combination speaker, microphone, and image sensor 2079. Together, user attached monitoring device 2065 includes a button 2083, a radial dial 2085, a display 2087, a combination speaker, microphone, and image sensor 2079 provide the user interface for user attached monitoring device 2065 and support the functionality of the various sensors discussed above in relation to FIG. 1B. Based upon the disclosure provided herein, one of ordinary skill in the art will recognize a variety of inputs and outputs that may be incorporated into user attached monitoring device 2065 to provide the functionality discussed herein.

Turning to FIG. 1D, a user attached monitoring device 1100 is shown with an example attachment element 1090 connected at opposite ends of a case 1089. User attached monitoring device 1100 is another example implementation of user attached monitoring device 110 of FIGS. 1A-1B. Attachment element 1090 is configured to securely attach a case 1089 to a limb of an individual in accordance with some embodiments. In various embodiments, attachment element 1090 includes electrically and/or optically conductive material used to make a conductive connection from one side of case 1089 to the opposite side of case 1089 and is used in relation to determining whether user attached monitoring device 1100 remains attached and/or has been tampered with. While FIG. 1D shows a strap as an example attachment element, based upon the disclosure provided herein, one of ordinary skill in the art will recognize other types of attachment elements that may be used in relation to different embodiments.

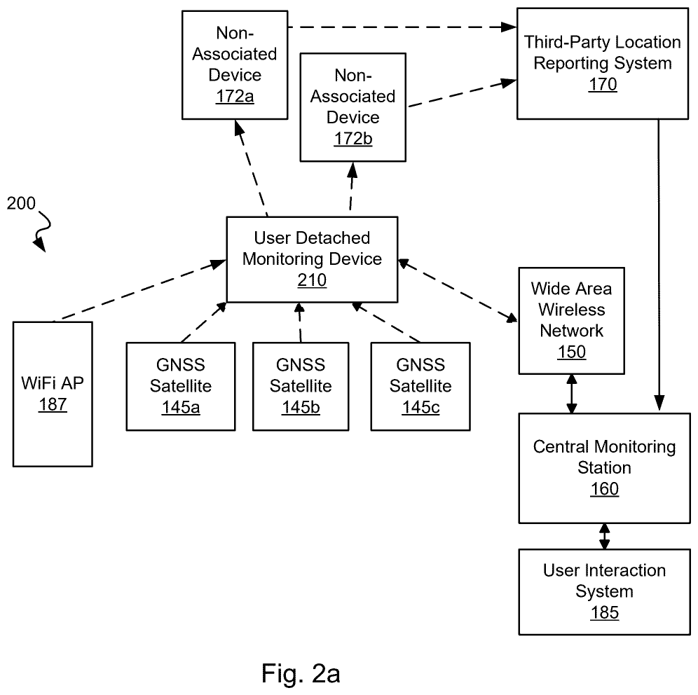

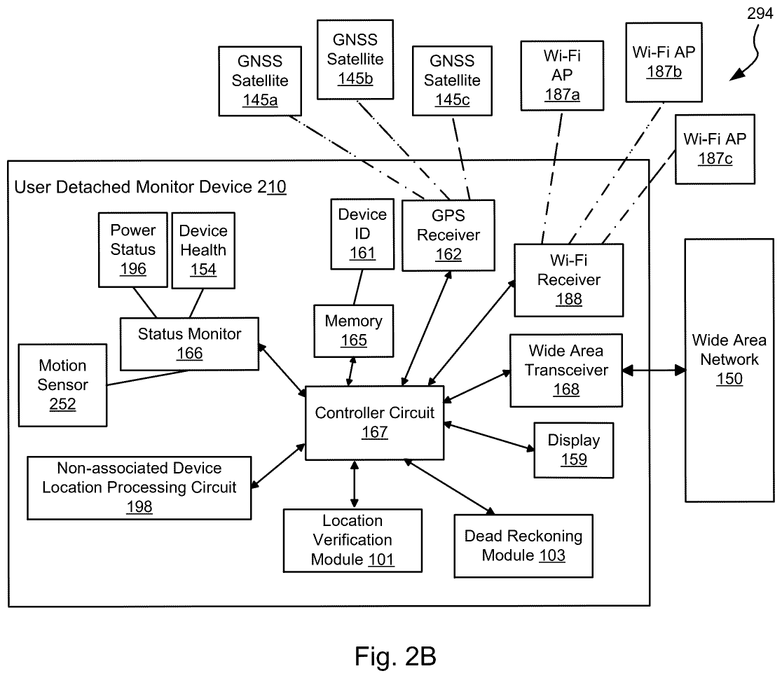

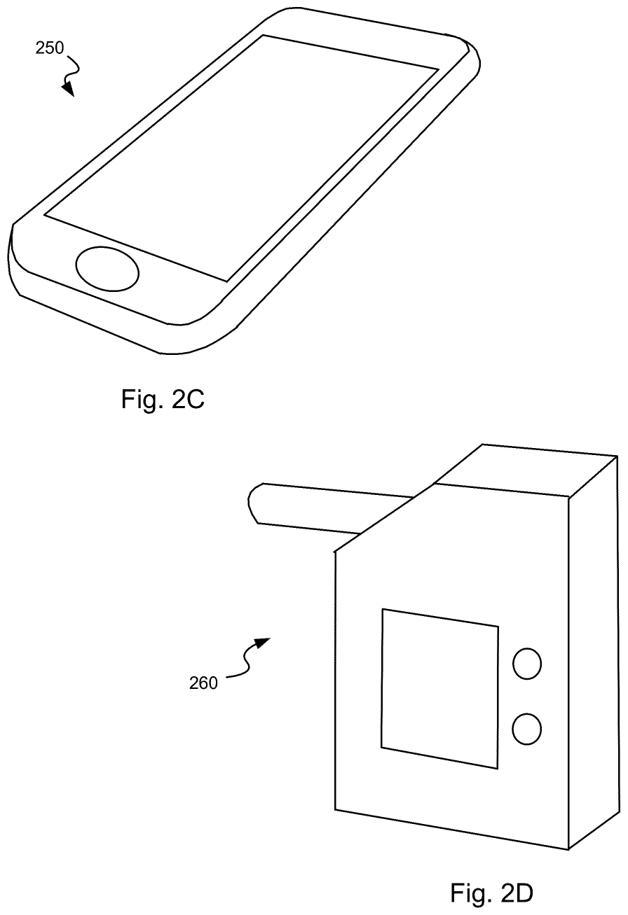

Turning to FIG. 2A, a block diagram illustrates a monitoring system 200 including a user detached monitoring device 210 and central monitoring station 160. User detached monitoring device 210 may include functionality similar to the user attached monitoring device 110 discussed above in relation to FIGS. 1A-1B, but is not attached to a monitored individual. Thus, user detached monitoring device 210 is referred to as a user detached monitoring device as opposed to a user attached monitoring device.

Turning to FIG. 2B, a block diagram 294 of an embodiment of user detached monitoring device 210 is shown in accordance with some embodiments. As shown, user detached monitoring device 210 includes functionality similar to that of user attached monitoring device 110 where in this case circuits and modules of the same number are used recognizing that the circuit and modules of the same number perform in relation to the user detached monitoring device 210 in place of the user attached monitoring device 110 as described above. There are a few differences from user attached monitoring device 110 including: the removal of shielding sensor 169, physical tamper sensor 151, and/or pulse/ECG sensor 1001; and replacing motion/proximity sensor 152 with a motion only sensor 252. Motion only sensor 252 provides the motion functionality of motion/proximity sensor 152, but not the proximity functionality. Based upon the disclosure provided herein, one of ordinary skill in the art will recognize a variety of modifications that may be made to both user attached monitoring device 110 and user detached monitoring device 210 in accordance with different embodiments.

Turning to FIG. 2C, a mobile phone 250 is shown as one implementation of user detached monitoring device 210. Turning to FIG. 2D, a mobile alcohol breath tester 260 is shown as another implementation of user detached monitoring device 210. Based upon the disclosure provided herein, one of ordinary skill in the art will recognize a variety of user detached monitoring devices that may be used in relation to different embodiments.

Turning to FIG. 3, a block diagram is shown of a location monitoring system 300 including a hybrid monitoring system 330 capable of establishing location using one or more of WiFi access point-based location determination circuitry, satellite-based location determination circuitry, and/or non-associated device-based location determination circuitry in accordance with various embodiments. Hybrid monitoring system 330 includes both a user attached monitoring device 310 and a user detached monitoring device 320. In some embodiments, user attached monitoring device 310 is similar to either user attached monitoring device 110; and user detached monitoring device 320 may be similar to user detached monitoring device 210.

User detached monitoring device 320 is portable and may be any device that is recognized as being used by or assigned to an individual being monitored, but is not physically attached to the individual being monitored by a tamper evident attaching device. User detached monitoring device 120 may be, but is not limited to, a cellular or mobile telephone configured to communicate with user attached monitoring device 310 via a local communication link 315. In contrast, user attached monitoring device 310 is attached to the individual being monitored using a tamper evident attaching device like a strap. User attached monitoring device 310 may be, but is not limited to, a tracking device that is attached around the limb of an individual and includes indicators to monitor whether the device has been removed from the individual or otherwise tampered.

Location monitoring system 300 further includes a central monitoring station 360 wirelessly coupled to user attached monitoring device 310 and/or user detached monitoring device 320 via one or more wide area wireless (e.g., cellular telephone network, Internet via a Wi-Fi access point, or the like) communication networks 350.

User detached monitoring device 320 includes a location sensor that senses the location of the device and generates a location data. The location data may comprise one or more of: global positioning system (“GPS”) data, Assisted GPS (“A-GPS”) data, Advanced Forward Link Trilateration (“AFLT”) data, and/or cell tower triangulation data. The aforementioned location data is utilized verify the location of a user associated with user detached monitoring device 320 at various points as more fully discussed below. User detached monitoring device 320 is considered “ambiguous” because it is not attached to the user in a tamper resistant/evident way, but rather is freely severable from the user and thus could be used by persons other than the target. Various processes discussed herein mitigate the aforementioned ambiguity to yield a reasonable belief that information derived from user detached monitoring device 320 corresponds to the target.

The location data and/or other data gathered by user detached monitoring device 320 may be wirelessly transmitted to central monitoring station 360 via wide area wireless network. Central monitoring station 360 may be any location, device or system where the location data is received, including by way of non-limiting example: a cellular/smart phone, an email account, a website, a network database, and a memory device. The location data is stored by central monitoring station 360 and is retrievable therefrom by a monitor, such as a parent, guardian, parole officer, court liaison, spouse, friend, or other authorized group or individual. In this manner, monitor is able to respond appropriately to the detected out-of-bounds activity by a user. In some cases, the monitor is able to retrieve the location data via a user interaction system 385 which may be, but is not limited to, a network connected user interface device communicatively coupled via a network to central monitoring station 360 and/or directly to user detached monitoring device 320 via wide area wireless network 350.

User detached monitoring device 320 may further include a user identification sensor operable to generate user identification data for identifying the user in association with the generation of the location data. The user identification data may comprise one or more of: image data, video data, biometric data (e.g. fingerprint, DNA, retinal scan, etc. data), or any other type of data that may be used to verify the identity of the user at or near the time the location data is generated. And the user identification sensor may comprise one or more of: a camera, microphone, heat sensor, biometric data sensor, or any other type of device capable of sensing/generating the aforementioned types of user identification data.

The user identification data is wirelessly transmitted in association with the location data to central monitoring station 360 via a wireless transmitter communicatively coupled to the user identification sensor. The user identification data is stored in association with the location data by central monitoring station 360 and is retrievable therefrom by a monitor, such as a parent, guardian, parole officer, court liaison, spouse, friend, or other authorized group or individual. The monitor is configured to retrieve the location data via a network connected user interface device communicatively coupled—via the network—to central monitoring station 360 and/or to user detached monitoring device 320. The location data may be transmitted to central monitoring station 360 independent of the user identification data, for example, during a periodic check-in with central monitoring system 360.

User detached monitoring device 320 may further comprise a memory communicatively coupled to a control unit—which is also communicatively coupled to the location sensor, the identification sensor and the wireless transceiver—for controlling the operations thereof in accordance with the functionalities described herein. The memory may include instructions (e.g., software of firmware based instructions) executable by the control unit to perform and/or enable various functions associated with user detached monitoring device 320. As user detached monitoring device 320 is portable, each of the components may be located within, immediately adjacent to, or exposed without, a device housing whose dimensions are such that user detached monitoring device 320 as a whole may be discretely carried by the user, for example, within a pocket or small purse.

Turning to FIG. 4, a flow diagram 400 shows a method in accordance with some embodiments for verifying location information provided from a monitoring device in a monitoring system. Following flow diagram 400, location information is received from a monitoring device (block 402). The monitoring device may be a type of user attached monitoring device similar to user attached monitoring device 110 or a type of user detached monitoring device similar to user detached monitoring device 210. The location information may be any type of location information generated by the monitoring device including, but not limited to, WiFi based location information, GNSS based location information, dead reckoning location information, and/or cell tower based location information. In some embodiments, the processes of flow diagram 400 are implemented as computer executable instructions executing on a processor of another monitoring device. In such embodiments, the location information may be received from the monitoring device generating the location information by the other monitoring device. In other embodiments, the processes of flow diagram 400 are implemented as computer executable instructions executing on a processor of a central monitoring station. In such embodiments, the location information may be received by the central monitoring station and from the monitoring device generating the location information.

It is determined whether context information (e.g., location information available from a context system) is already available for the received location information (block 404). Where the processes of FIG. 4 are being performed by another monitoring device associated with the monitored individual to which the monitoring device providing the location information is associated, the context information may include, but is not limited to, location information generated by the receiving monitoring device (i.e., the other monitoring device), or a dead reckoning module of the monitoring device from which the location information is received. Alternatively, where the processes of FIG. 4 are being performed by a central monitoring station, the context information may include, but is not limited to, location information generated and provided to the central monitoring station by another monitoring device associated with the monitored individual to which the monitoring device providing the location information is associated, from a third-party location reporting system, and/or from a dead reckoning module of the monitoring device from which the location information is received.

Where any context information is available, it is compared with the received location information (block 416). This comparison may include, but is not limited to, subtracting an X coordinate of the received location information from an X coordinate of the context information to yield an X difference, and subtracting a Y coordinate of the received location information from a Y coordinate of the context information to yield a Y difference. An offset is then calculated in accordance with the following equation:

Offset=Square Root[(X difference)²+(Y difference)²].

It is determined if the offset is greater than a defined threshold (block 418). In some embodiments, the defined threshold may be a user programmable value. Based upon the disclosure provided herein, one of ordinary skill in the art will recognize a variety of defined thresholds that may be used in relation to different embodiments.

Where it is determined that the offset is greater than the defined threshold (block 418), an indication that the received location information is not accurate is generated (block 420). Where the processes of FIG. 4 are being performed in another monitoring device, this indication of inaccurate location information may be sent to a central monitoring station by the monitoring device performing the processes of FIG. 4. Alternatively, where it is determined that the offset is not greater than the defined threshold (block 418), an indication that the received location information is accurate is generated (block 412). Where the processes of FIG. 4 are being performed in another monitoring device, this indication of accurate location information may be sent to a central monitoring station by the monitoring device performing the processes of FIG. 4. This indication of accuracy or inaccuracy may be forwarded to, for example, a monitoring individual who may use it to determine how to approach the monitored individual.

Alternatively, where context information is not available (block 404), it is determined whether it is time to verify the received location information (block 406). In some embodiments, a timer is used to indicate a time when location information should be re-verified. The timer is restarted after verification is completed (e.g., in block 412, 418, 420). Where the timer expires, re-verification is done regardless of the availability of context information. Where the context information is not available (block 404) and it is time to confirm the location veracity (block 406), context information is obtained (block 414). Where the processes of FIG. 4 are being performed by another monitoring device associated with the monitored individual to which the monitoring device providing the location information is associated, obtaining the context information may include, but is not limited to, enabling generation of location information by the receiving monitoring device (i.e., the other monitoring device). This may be done, for example, by enabling GNSS or WiFi location determination circuitry on the receiving monitoring device. Alternatively, where the processes of FIG. 4 are being performed by a central monitoring station, obtaining the context information may include, but is not limited to, enabling location determination via associated devices and a third-party location reporting system. The obtained context information (block 414) is compared with the received location information (block 416) and an accuracy determination is made (block 418) and indicated (blocks 412, 420) as described above.

Alternatively, where it is not time to confirm location veracity (block 406), it is determined whether dead reckoning information is available from the monitoring device from which the location information is received (block 408). Where such dead reckoning information is available (block 408), it is determined whether an estimated location of the monitoring device (i.e., the monitoring device from which the location information was received) generated by a dead reckoning module on the monitoring device differs significantly from the received location information (block 410). This may be determined, for example, by comparing the estimated location to a time variable threshold. Such a time variable threshold may increase over time as the accuracy of a dead reckoning module would be expected to decrease over time. Thus, for example, the time variable threshold may be ten feet for one minute from when a previously verified location information from the monitoring device was verified, and one hundred feet for ten minutes from when a previously verified location information from the monitoring device was verified. Where the estimated location is significantly greater than the received location information (block 410), an indication that the received location information is not accurate is generated (block 420). Alternatively, where the estimated location is not significantly greater than the received location information (block 410), an indication that the received location information is accurate is generated (block 412). Where the processes of FIG. 4 are being performed in another monitoring device, the indications of accurate or inaccurate location information may be sent to a central monitoring station by the monitoring device performing the processes of FIG. 4. This indication of accuracy or inaccuracy may be forwarded to, for example, a monitoring individual who may use it to determine how to approach the monitored individual.

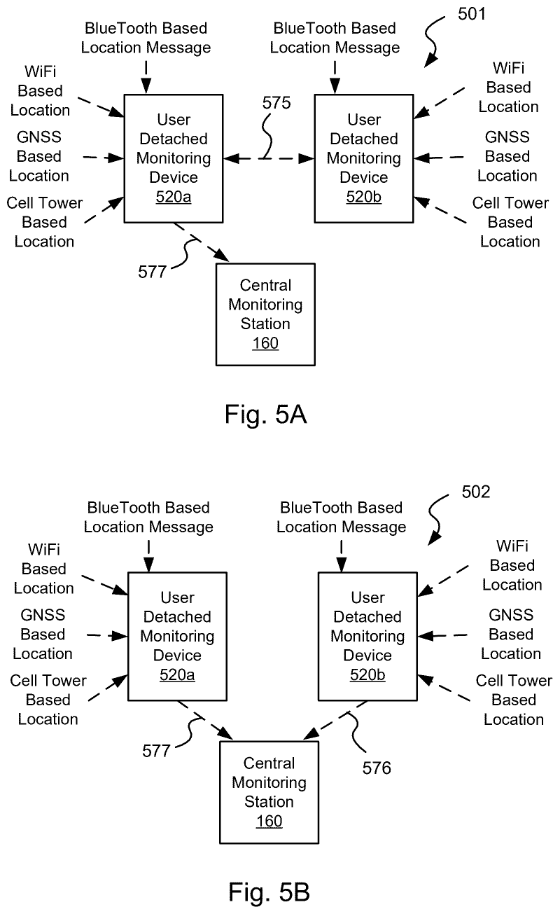

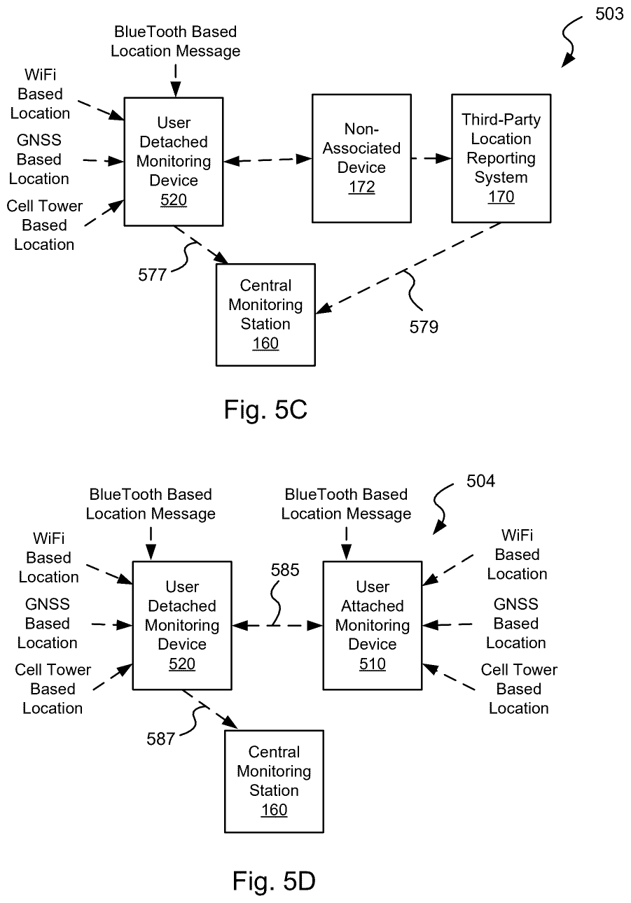

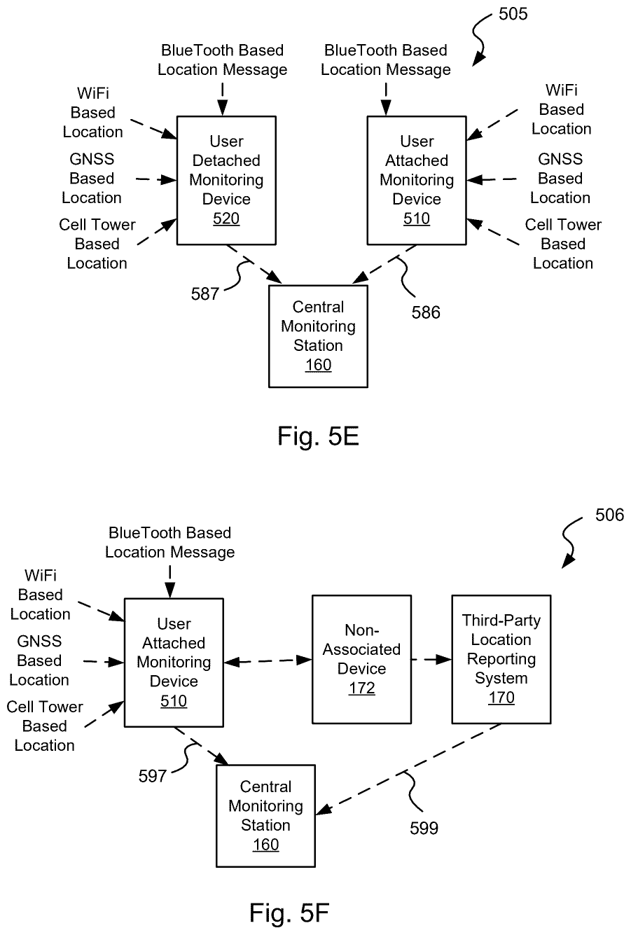

Turning to FIGS. 5A-5F, different verification scenarios that may be used in relation to various embodiments. FIG. 5A shows a verification scenario 501 where a first user detached monitoring device 520a generates location information 577 based upon one or more of: a BlueTooth™ based location message, a WiFi based location, a GNSS based location, and/or a cell tower based location; and a second user detached monitoring device 520b generates location information 575 based upon one or more of: a BlueTooth™ based location message, a WiFi based location, a GNSS based location, and/or a cell tower based location. First user detached monitoring device 520a may be, but is not limited to, a mobile phone, or a mobile alcohol breath tester; and second user detached monitoring device 520b may be, but is not limited to, a mobile phone, or a mobile alcohol breath tester. The location information 575 from second user detached monitoring device 520b is provided to first user detached monitoring device 520a. In this scenario, second user detached monitoring device 520b is a context system providing context information in the form of location information that is used by first user detached monitoring device 520a to determine the accuracy (i.e., veracity) of location information 577. The determination of accuracy may be provided to central monitoring station 160 along with location information 577.

FIG. 5B shows a verification scenario 502 where first user detached monitoring device 520a generates location information 577 based upon one or more of: a BlueTooth™ based location message, a WiFi based location, a GNSS based location, and/or a cell tower based location; and a second user detached monitoring device 520b generates location information 576 based upon one or more of: a BlueTooth™ based location message, a WiFi based location, a GNSS based location, and/or a cell tower based location. The location information 576 from second user detached monitoring device 520b is provided to central monitoring station 160. In this scenario, second user detached monitoring device 520b is a context system providing context information in the form of location information that is used by central monitoring station 160 to determine the accuracy (i.e., veracity) of location information 577.

FIG. 5C shows a verification scenario 503 where user detached monitoring device 520 generates location information 577 based upon one or more of: a BlueTooth™ based location message, a WiFi based location, a GNSS based location, and/or a cell tower based location; and a non-associated device 172 in communication with user detached monitoring device 520 provides the location of non-associated device 172 to third-party location reporting system 170. The location of non-associated device 172 is reported as a proxy location 579 (a proxy for the location of user detached monitored device 520) to central monitoring station 160. In this scenario, the combination of non-associated device 172 and third-party location reporting system 170 are a context system providing context information in the form of location information that is used by central monitoring station 160 to determine the accuracy (i.e., veracity) of location information 577.

FIG. 5D shows a verification scenario 504 where user detached monitoring device 520 generates location information 587 based upon one or more of: a BlueTooth™ based location message, a WiFi based location, a GNSS based location, and/or a cell tower based location; and a user attached monitoring device 510 generates location information 585 based upon one or more of: a BlueTooth™ based location message, a WiFi based location, a GNSS based location, and/or a cell tower based location. User detached monitoring device 520 may be, but is not limited to, a mobile phone, or a mobile alcohol breath tester; and user attached monitoring device 510 may be, but is not limited to, a wrist worn monitoring device, or an ankle worn monitoring device. The location information 585 from user attached monitoring device 510 is provided to user detached monitoring device 520. In this scenario, user attached monitoring device 510 is a context system providing context information in the form of location information that is used by user detached monitoring device 520 to determine the accuracy (i.e., veracity) of location information 587. The determination of accuracy may be provided to central monitoring station 160 along with location information 587.

FIG. 5E shows a verification scenario 505 where user detached monitoring device 520 generates location information 587 based upon one or more of: a BlueTooth™ based location message, a WiFi based location, a GNSS based location, and/or a cell tower based location; and a user attached monitoring device 510 generates location information 586 based upon one or more of: a BlueTooth™ based location message, a WiFi based location, a GNSS based location, and/or a cell tower based location. The location information 586 from user attached monitoring device 510 is provided to central monitoring station 160. In this scenario, user attached monitoring device 510 is a context system providing context information in the form of location information that is used by central monitoring station 160 to determine the accuracy (i.e., veracity) of location information 587.

FIG. 5F shows a verification scenario 506 where user attached monitoring device 510 generates location information 597 based upon one or more of: a BlueTooth™ based location message, a WiFi based location, a GNSS based location, and/or a cell tower based location; and a non-associated device 172 in communication with user attached monitoring device 510 provides the location of non-associated device 172 to third-party location reporting system 170. The location of non-associated device 172 is reported as a proxy location 599 (a proxy for the location of user attached monitored device 510) to central monitoring station 160. In this scenario, the combination of non-associated device 172 and third-party location reporting system 170 are a context system providing context information in the form of location information that is used by central monitoring station 160 to determine the accuracy (i.e., veracity) of location information 597.

It is noted that the verification scenarios discussed in relation to FIGS. 5A-5F is not an exhaustive set of scenarios possible in accordance with different embodiments. Based upon the disclosure provided herein, one of ordinary skill in the art will recognize a variety of other verification scenarios using a combination of two or more of: a user detached monitoring device(s), user attached monitoring device(s), third-party location reporting systems, and/or dead reckoning modules implemented in one or both of a user attached monitoring device or a user attached monitoring device.

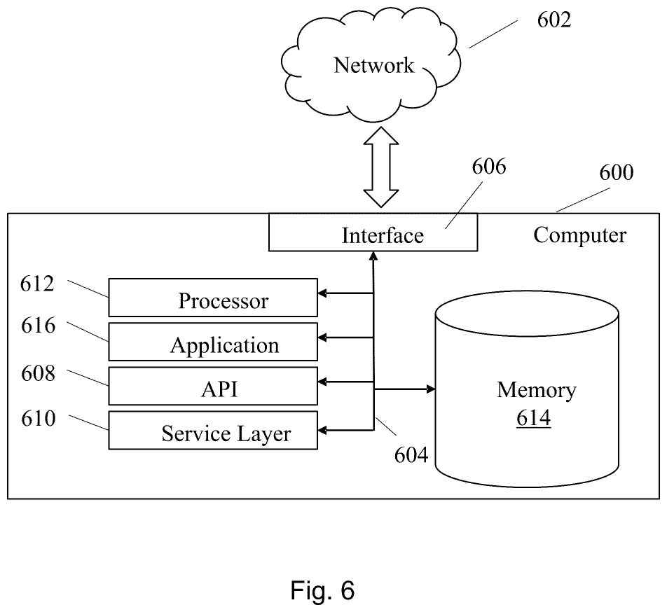

In some embodiments, one or more of user attached monitoring device 110, user detached monitoring device 210, central monitoring station 160, user interaction system 185, third-party reporting system 170, non-associated device 172, user attached monitoring device 310, and/or user detached monitoring device 320 may be implemented, either in total or in part, on a computer system. FIG. 6 is a block diagram of a computer system 600 used to provide computational functionalities associated with described algorithms, methods, functions, processes, flows, and procedures as described in the instant disclosure, according to an implementation. Computer system 600 is one example of a large number of computer systems that may be used to implement different embodiments. Based upon the disclosure provided herein, one of ordinary skill in the art will recognize a wide variety of computer systems that may be used in relation to different embodiments.

Computer system 600 is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, computer system 600 may include a computer that includes an input device, such as a keypad, keyboard, touch screen, or other device that can accept user information, and an output device that conveys information associated with the operation of computer system 600, including digital data, visual, or audio information (or a combination of information), or a GUI.

Computer system 600 can serve in a role as a client, network component, a server, a database or other persistency, or any other component (or a combination of roles) of a computer system for performing the subject matter described in the instant disclosure. Computer system 600 is communicably coupled with a network 602. In some implementations, one or more components of computer system 600 may be configured to operate within environments, including cloud-computing-based, local, global, or other environment (or a combination of environments).

At a high level, computer system 600 is an electronic computing device operable to receive, transmit, process, store, or manage data and information associated with the described subject matter. According to some implementations, computer system 600 may also include or be communicably coupled with an application server, e-mail server, web server, caching server, streaming data server, business intelligence (BI) server, or other server (or a combination of servers).

Computer system 600 can receive requests over network 602 from a client application (for example, executing on another computer system (not shown) and responding to the received requests by processing the said requests in an appropriate software application. In addition, requests may also be sent to computer system 600 from internal users (for example, from a command console or by other appropriate access method), external or third-parties, other automated applications, as well as any other appropriate entities, individuals, systems, or computers.

Each of the components of computer system 600 can communicate using a system bus 604. In some implementations, any or all of the components of the computer system 600, both hardware or software (or a combination of hardware and software), may interface with each other or interface 606 (or a combination of both) over system bus 604 using an application programming interface (API) 608 or a service layer 610 (or a combination of API 608 and service layer 610. API 608 may include specifications for routines, data structures, and object classes. API 608 may be either computer-language independent or dependent and refer to a complete interface, a single function, or even a set of APIs. Service layer 610 provides software services to computer system 600 or other components (whether or not illustrated) that are communicably coupled to computer system 600. The functionality of computer system 600 may be accessible for all service consumers using this service layer. Software services, such as those provided by service layer 610, provide reusable, defined business functionalities through a defined interface. For example, the interface may be software written in JAVA, C++, or other suitable language providing data in extensible markup language (XML) format or other suitable format. While illustrated as an integrated component of computer system 600, alternative implementations may illustrate API 608 or service layer 610 as stand-alone components in relation to other components of computer system 600 or other components (whether or not illustrated) that are communicably coupled to computer system 600. Moreover, any or all parts of API 608 or service layer 610 may be implemented as child or sub-modules of another software module, enterprise application, or hardware module without departing from the scope of this disclosure.

Computer system 600 includes an interface 606. Although illustrated as a single interface 606 in FIG. 6, two or more interfaces 606 may be used according to particular needs, desires, or particular implementations of computer system 600. Interface 606 is used by computer system 600 for communicating with other systems in a distributed environment that are connected to the network 602. Generally, the interface 606 includes logic encoded in software or hardware (or a combination of software and hardware) and operable to communicate with the network 602. More specifically, the interface 606 may include software supporting one or more communication protocols associated with communications such that the network 602 or interface's hardware is operable to communicate physical signals within and outside of the illustrated computer system 600.

Computer system 600 includes at least one computer processor 612. Although illustrated as a single computer processor 612 in FIG. 6, two or more processors may be used according to particular needs, desires, or particular implementations of computer system 600. Generally, the computer processor 612 executes instructions and manipulates data to perform the operations of computer system 600 and any algorithms, methods, functions, processes, flows, and procedures as described in the instant disclosure.

Computer system 600 also includes a memory 614 that holds data for computer system 600 or other components (or a combination of both) that may be connected to the network 602. For example, memory 614 may be a database storing data consistent with this disclosure. Although illustrated as a single memory 614 in FIG. 6, two or more memories may be used according to particular needs, desires, or particular implementations of computer system 600 and the described functionality. While memory 614 is illustrated as an integral component of computer system 600, in alternative implementations, memory 614 may be external to computer system 600.

In addition to holding data, the memory may be a non-transitory medium storing computer readable instruction capable of execution by computer processor 612 and having the functionality for carrying out manipulation of the data including mathematical computations.

Application 616 is an algorithmic software engine providing functionality according to particular needs, desires, or particular implementations of computer system 600, particularly with respect to functionality described in this disclosure. For example, application 616 can serve as one or more components, modules, applications, etc. Further, although illustrated as a single application 616, application 616 may be implemented as multiple applications 616 on computer system 600. In addition, although illustrated as integral to computer system 600, in alternative implementations, application 616 may be external to computer system 600.

There may be any number of computers 600 associated with, or external to, a computer system containing computer system 600, each computer system 600 communicating over network 602. Further, the term “client,” “user,” and other appropriate terminology may be used interchangeably as appropriate without departing from the scope of this disclosure. Moreover, this disclosure contemplates that many users may use one computer system 600, or that one user may use multiple computers 600.

In some embodiments, computer system 600 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AlaaS), and/or function as a service (FaaS).

In conclusion, the present invention provides for novel systems, devices, and methods for providing location information for a tracking device. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for determining the location of a monitored individual, the method comprising:
generating, by a monitoring device, a first location information for the monitoring device, wherein the monitoring device is associated with the monitored individual:
receiving, from a context system, a second location information for the monitoring device;
comparing the first location information with the second location information; and
indicating a veracity of the first location information based at least in part on comparing the first location information with the second location information.

2. The method of claim 1, wherein the monitoring device is a user attached monitoring device and the context system comprises a user detached monitoring device associated with the monitored individual.

3. The method of claim 1, wherein the monitoring device is a user detached monitoring device and the context system comprises a user attached monitoring device associated with the monitored individual.

4. The method of claim 1, wherein:
the context system comprises a non-associated device and a third-party reporting system; and
the monitoring device is selected from a group consisting of: a user attached monitoring device, and a user detached monitoring device.

5. The method of claim 1, wherein the method further comprises:
receiving, by a central monitoring station, both the first location information and the second location information; and
wherein comparing the first location information with the second location information and indicating the veracity of the first location information is done by the central monitoring station.

6. The method of claim 1, wherein the method further comprises:
receiving, by the monitoring device, the second location information; and
wherein comparing the first location information with the second location information and indicating the veracity of the first location information is done by the monitoring device.

7. The method of claim 6, the method further comprising:
transmitting, by the monitoring device, the first location information to a central monitoring station; and
wherein indicating the veracity of the first location information based at least in part on comparing the first location information with the second location information comprises:
generating a veracity indication based at least in part on comparing the first location information with the second location information; and
transmitting the veracity indication to the central monitoring station.

8. The method of claim 1, wherein the context system comprises a dead reckoning module of the monitoring device.

9. The method of claim 1, wherein the monitoring device is selected from a group consisting of: a user detached monitoring device, and a user attached monitoring device; wherein the user detached monitoring device is selected from a group consisting of: a mobile phone, and a mobile alcohol breath tester; and wherein the user attached monitoring device is selected from a group consisting of: a wrist worn monitoring device, and an ankle worn monitoring device.

10. An individual location monitoring system, the system comprising:
a monitoring device associated with a monitored individual configured to generated a first location information;
a context system configured to generate a second location information;
a processor; and
a computer readable medium communicably coupled to the processor, and having stored therein instructions which when executed by the processor cause the processor to:
receive the second location information;
compare the first location information with the second location information; and
indicate a veracity of the first location information based at least in part on comparing the first location information with the second location information.

11. The system of claim 9, wherein the monitoring device is a user attached monitoring device and the context system comprises a user detached monitoring device associated with the monitored individual.

12. The system of claim 9, wherein the monitoring device is a user detached monitoring device and the context system comprises a user attached monitoring device associated with the monitored individual.

13. The system of claim 9, wherein:
the context system comprises a non-associated device and a third-party reporting system; and
the monitoring device is selected from a group consisting of: a user attached monitoring device, and a user detached monitoring device.

14. The system of claim 9, wherein the processor is incorporated in a central monitoring station, and wherein the instructions which when executed by the processor further cause the processor to:
receive the first location information.

15. The system of claim 9, wherein the processor is incorporated in the monitoring device.

16. The system of claim 15, wherein the instructions which when executed by the processor further cause the processor to:
transmit the first location information to a central monitoring station; and
wherein indicating the veracity of the first location information based at least in part on comparing the first location information with the second location information comprises:
generating a veracity indication based at least in part on comparing the first location information with the second location information; and
transmitting the veracity indication to the central monitoring station.

17. The system of claim 9, wherein the context system comprises a dead reckoning module of the monitoring device.

18. The system of claim 9, wherein the monitoring device is selected from a group consisting of: a user detached monitoring device, and a user attached monitoring device.

19. The system of claim 18, wherein the user detached monitoring device is selected from a group consisting of: a mobile phone, and a mobile alcohol breath tester.

20. The system of claim 18, wherein the user attached monitoring device is selected from a group consisting of: a wrist worn monitoring device, and an ankle worn monitoring device.
